(19) United States
(12) Patent Application Publication
(10) Pub. No.: US 2026/0091993 A1
(43) Pub. Date: Apr. 2, 2026

(54) Water Treatment Systems

(71) Applicant: Prescott Holdings, LLC, Portsmouth, NH (US)

(72) Inventors: Michael Robert Kelsey, Waltham Abbey (GB); Stephen Mann, New York, NY (US); Robert Bradley Kelsey, Chesham (GB); Stephen Michael McKenzie, Portsmouth, NH (US)

(21) Appl. No.: 18/904,549

(22) Filed: Oct. 2, 2024

(51) Int. Cl. C02F 1/34; C02F 1/00; C02F 1/50; C02F 101/34; C02F 103/00

(52) U.S. Cl. CPC C02F 1/34; C02F 1/008; C02F 1/50; C02F 2101/34; C02F 2103/007; C02F 2303/04

(57) ABSTRACT

A water treatment system for the treatment of red tide contaminated water is provided. The system utilizes a cavitation system combined with the addition of compressed air or concentrated oxygen into the fluid flow. The system is able to very efficiently destroy red tide organisms as well as the toxins they create—brevetoxins.

### BACKGROUND OF THE INVENTION

The present disclosure relates generally to water treatment systems. More particularly, the present disclosure relates to a water treatment system which utilizes compressed air coupled with hydrodynamic cavitation to effectively treat contaminated water such as red tide contaminated water as well as the toxins generated thereby.

Red tide, generally caused by the organism Karena brevis, is a pervasive, toxic, and ecologically damaging infestation which is becoming increasingly prevalent and increasingly damaging in recent years. Red tide has proven very hard to process and treat due to its widespread growth and contamination over large areas and bodies of water.

A great need exists for effective and economical treatment of red tide to kill not only the red tide organism itself, but also to effectively break down the toxins that it releases. Red tide causes enormous amounts of damage to wildlife, plants, property, and economies due to lost tourism.

The process of eliminating red tide has two parameters: kill the live red tide cells and remove the toxins the cells produce. Red tide produces several toxins (brevetoxins), each has potentially serious, even fatal effects on marine life and humans. Somewhat paradoxically, the more red tide cells that are destroyed, the more toxins are released. Therefore, the more effective the cell destruction is, the harder one has to work to remove the toxins. Thus, there are many challenges faced when seeking a red tide water treatment system.

Therefore, what is needed is a treatment system that is able to destroy red tide organisms as well as breakdown brevetoxins in an efficient and practical manner capable of being deployed at a scale large enough to treat bodies of water.

### SUMMARY OF THE INVENTION

The subject matter of this application may involve, in some cases, interrelated products, alternative solutions to a particular problem, and/or a plurality of different uses of a single system or article.

In one aspect, a system for treatment of water comprising a harmful algal bloom or red tide is provided. The system has a cavitation chamber having a fluid inlet to receive a water flow comprising contaminant organisms and/or biological toxins, a fluid outlet, and a cavitation structure between the inlet and the outlet operable to cause a cavitation of fluid passing through the cavitation chamber at a predetermined minimum flow rate. A pump is used to convey fluid through the cavitation chamber. The system further comprises an air compressor in communication with the cavitation chamber. This air compressor operates to introduce oxygen into the cavitation chamber, aiding in oxidation of the target organisms and toxins in combination with cavitation. An injector is in communication with the air compressor and positioned so as to introduce compressed air from the air compressor into a flow path defined by the cavitation chamber upstream of the cavitation structure.

In another aspect, a system for treatment of water comprising a harmful algal bloom and/or red tide and related toxins is provided. The system comprises a cavitation chamber having a fluid inlet to receive a water flow comprising the harmful algal bloom and/or red tide and related toxins, a fluid outlet, and a cavitation structure operable to cause a cavitation of fluid passing through at a predetermined minimum flow rate. A pump is used to convey fluid through the cavitation chamber. The system further comprises an air compressor in communication with the cavitation chamber. This air compressor operates to introduce compressed air into the cavitation chamber, aiding in oxidation of the target organisms and toxins in combination with cavitation. A venturi injector is in communication with the air compressor and positioned so as to introduce compressed air from the air compressor into a flow path defined by the cavitation chamber.

In yet another aspect, a method of treating water comprising contaminants including, for example, Karena brevis and brevetoxins is provided. The method involves positioning a fluid intake into a body of contaminated water. The fluid intake is in communication with a water treatment device comprising a hydrodynamic cavitation chamber and an air compressor to introduce compressed air to fluid flow within the cavitation chamber. The method further involves activating a pump to convey the water through the cavitation chamber, and activating the air compressor to introduce the compressed air to the water flow. The step of activating the pump comprises conveying fluid at a flow rate sufficient to cause cavitation of the water within the cavitation chamber. The method further involves conveying the fluid back to the body of water after passing through the cavitation chamber, the fluid at an outlet of the cavitation chamber having no, or only a trace amount of Karena brevis or brevetoxin.

### BRIEF DESCRIPTION OF DRAWINGS

FIG. 1 provides a view of an embodiment of the present disclosure.

FIG. 2 provides a view of an embodiment of the present disclosure using venturi injector.

FIG. 3 provides a view of an embodiment of the cavitation structure of the present disclosure.

FIG. 4 provides a view of an embodiment of the present disclosure having variable cavitation flow chamber configurations.

FIG. 5 provides a flow chart of treatment of water contaminated with red tide and brevetoxin showing an initial cell and toxin concentration, as well as outlet concentrations after two different treatments.

### DETAILED DESCRIPTION OF THE INVENTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Prior art cavitation systems are known for water treatment as well as other fluid treatment and reaction systems. However, none have been applied to red tide contamination or even other microbial contamination (such as, e.g. algae contamination and the like). Further, the prior art does not utilize compressed air for the purpose of increasing the amount of oxygen present in the system. Increased oxygen availability increases reactions with organic mater and thus is highly advantageous for destruction and denaturing of organic molecules and organisms. Other prior art systems utilize venturi devices as ways to cause cavitation, but fail to utilize both a venturi device to introduce compressed air to the system combined with a separate cavitation device within the fluid flow path. Other prior art systems introduce gas at the cavitation area and during cavitation. By contrast, in many embodiments, the present system introduced compressed air upstream as a way to increase oxygen in the system (dissolved, entrained, flowing with the liquid, and the like). The present system need not have saturated, or super saturated oxygen (or any other component) in order to effectively operate. In testing, treatment using only a cavitation system was found to be insufficient to meet the results required for treatment of water contaminated with the target organism.

Hydrodynamic cavitation is a phenomenon that occurs when the pressure of a liquid drops below its vapor pressure, causing the formation and collapse of vapor bubbles. This collapse generates intense local heating, high pressures, and shock waves, leading to physical and chemical effects within the liquid.

Generally, the present disclosure concerns a water treatment system for the treatment of red tide (Karena brevis) as well as the toxins produced by the red tide (brevetoxins). The system is able to be deployed at a large scale for treatment of substantial volumes of contaminated water, such as open bodies of water. The system contemplated herein utilizes a combination of hydrodynamic cavitation with oxygen supplementation in the form of compressed air or in some cases, concentrated oxygen. The system has a cavitation chamber for the contaminated water to flow through, a water intake piping, pump, and optional intake screen or filter to prevent drawing in of large solids. A compressed air or other gas inlet is positioned upstream from the cavitation section of the cavitation chamber, allowing introduction of compressed air (or concentrated oxygen and the like). At an end of the cavitation chamber is a fluid outlet and related piping to return the treated water to the body of water being treated, or to a separate location. The cavitation chamber as used generally herein refers not only to the cavitation structure, but also flid flow paths (piping, tubing, etc.) leading to and from the cavitation structure, as well as, in some cases, valving, an inlet and an outlet. Surprisingly, and unlike prior art systems, the present disclosure is able to adequately treat water using only compressed air or concentrated oxygen combined with cavitation chamber, without additional water treatment systems such as ozone treatment, ultraviolet, chemical treatments, and the like, as known in the art.

The presently disclosed systems are efficient and practical enough to be capable of deployment at a scale large enough to treat even large bodies of water such as lakes, rivers, ocean areas such as bays, and the like.

The terms “red tide” and “algae” are sometimes used interchangeably by laymen. From a biological and scientific standpoint, they are completely different organisms. They have different life cycles, different biology, and different ways they damage the environment and cause health risks. Importantly, Red Tide organisms release a number of different toxins called brevetoxins which cause health issues to animals and humans, as well as plant life. One particular challenge when addressing a red tide contamination even is that even upon killing or destruction of the red tide organism, the brevetoxins remain in the water and must be removed as well. Additional brevetoxins are released during the destruction of the red tide organism, making brevetoxin removal an even more pressing concern. Therefore, adequate treatment of red tide contamination requires both the destruction of the red tide organism as well as the brevotoxins it has created in the water.

In some embodiments configured to draw water from an open body of water, an inlet manifold may be used to draw in water from a broad area and different directions of flow to prevent clogging or inlet of larger materials. A filter, mesh, screen, or plurality of openings may allow for more efficient fluid intake into the system. In some embodiments, the buoyancy of the inlet manifold or inlet hose/piping may be adjusted so as to control location of water intake (bottom, middle, top surface, and the like).

In some embodiments, an outlet manifold may be used to disperse treated water into the body of water or to a drainage area. The manifold may evenly distribute outlet water over a wider area than a simple outlet hose or pipe (which may also be used). Depending on configuration, the outlet may be positioned far from the inlet, which prevents dilution of the red tide organism, or may be positioned close to the inlet to directly treat and dilute a focused area.

During development of the present system, a number of water treatment modalities were experimented with. It was unexpectedly discovered that hydrodynamic cavitation, discussed herein, provided not only very cost effective treatment, but also highly effective treatment in the destruction of harmful algal blooms (HAB), as well as both red tide organism and the brevetoxins it releases. Different from red tide, harmful algal blooms are known in the art to refer to a concentration of certain undesirable algae in water greater than a predetermined amount which causes negative impacts to the water health, making it unsuitable for, e.g. plant or animal growth, human swimming and nearby habitation, unsuitable as drinking water, and the like.

Surprisingly, when combined with the introduction of low cost compressed air or concentrated oxygen to increase the overall oxygen availability within the flowing water in the treatment system, results were equal if not better than alternative systems which are also far more costly to implement and operate. In other words, in typical embodiments of this system the compressed air and cavitation chamber are the only components used for reduction in contamination of the water, unlike other systems which require additional water treatment components. Accordingly, the presently disclosed systems may be used for treatment of water having a red tide contamination as well as for treatment of water suffering from other HABs as well.

During testing, it was discovered that the presence of additional oxygen (over the typical atmospheric amount) makes a substantial difference in the destruction of red tide organisms and brevetoxins. Indeed, in many cases, additional oxygen addition to the system is needed to adequately destroy both targets. By compressing air at higher than atmospheric pressure (for example double (2 atm) or triple atmospheric (3 atm) pressure) the amount of oxygen in a given volume is greatly increased. In common testing examples, it was found that the use of compressed air at approximately twice (+/−15%) atmospheric pressure (2 atm) or greater provided meaningfully superior results compared to only slightly compressed air. Again, the higher the compression, the more oxygen will be present in a given volume and therefore the more oxygen is available for reaction to break down the target organic matter. Thus, compressed air is able to introduce a substantial amount of oxygen to the water to be treated in a relatively small volume, and without requiring an excessive volume of gas, which will disrupt cavitation and make treatment less effective.

In any event, the introduction of the air must be at a pressure that is higher than the internal pressure of the fluid flow at the location of introduction, else the air will be prevented from entering by the higher pressure liquid. For example, if the system internal water pressure is 1.5 atm, the gas would have to be pressurized higher than this to urge its way in against the water pressure. In another embodiment, if the system internal water pressure is 0.9 atm, atmospheric air could be introduced. While preferably compressed air is used due to its higher oxygen amount by total volume of gas, atmospheric pressure air may also be used in certain applications without straying from the scope of this invention.

More readily available oxygen in the flow facilitates the chemical reactions that break down and destroy red tide and brevetoxins. In particular, the more dissolved oxygen in the water, the better. However, entrained and mixed bubbles of oxygen are also very helpful for treatment, as they provide additional surfaces for interaction with the oxygen, and also provide gaseous oxygen that can be later dissolved into the water, as the existing dissolved oxygen is consumed in reactions with biologic material, such as the problematic red tide and other harmful algae blooms, among others.

Compressed gas, namely the oxygen introduced by compressed air, has been unexpectedly found to continue the effective breakdown of total biologic components even after processing and leaving the system. For example, very small gas quantities, such as micrometer or nanometer sized bubbles (which are produced during presently disclosed the cavitation process) do not float and thus can stay in the discharged water after treatment for days. Cavitation aids in making the gas into very small bubbles widely distributed throughout the outlet flow. The bubbles may eventually re-dissolve as the dissolved oxygen in the water reduces below saturation, thus extending the time that water is being effectively treated by the introduction of oxygen which then breaks down problematic components in the water body.

While the use of concentrated oxygen is also able to achieve a similar effect, compressed air is more readily available, has lower operational costs, is more robust and less dangerous (potential fire and explosion risk) and uses simple machinery that is less likely to breakdown and easier to repair. An oxygen concentrator, while more complex, sensitive, and expensive than an air compressor is still less so compared to an ozone generator, which carries even more complex, sensitive, and expensive-to-operate challenges than the oxygen concentrator. Thus, the oxygen concentrator embodiment represents a middle ground with efficiency advantages over an ozone system.

The compressed air (or concentrated oxygen or the like) may be introduced into the system at one or more places along the flow path of the cavitation system. In a typical embodiment, the compressed air is introduced upstream of the initial cavitation section. This may allow the gas to diffuse into and dissolve into the water before the disruption caused by the cavitation, thus making the oxygen more widely available for reaction with the target organism and toxins. As noted above, the primary goal with the introduction of the gas is to increase the available oxygen available in the water treatment system. In further embodiments, additional injection ports may be present along the length of the cavitation flow path, either concurrent with an area of cavitation, or in a section of non-cavitation flow. In a particular embodiment, a venturi device is used as an injector to inject the compress gas into the fluid flow piping. In other embodiments, other injectors (i.e. structures to introduce gas into the fluid flow) may be used, for example, a check valve.

In one particular embodiment, the Venturi injector or other gas inlet structure is positioned to introduce compressed air at a low pressure side of a water supply pump. This provides an efficient location because the pressure is lower, allowing easier gas introduction, and because pumping agitates the mixture, aiding in the dissolving of oxygen into the water. Venturi devices allow for precise metering and control of gas flow. In situations where exact metering isn't required, a more simple structure just bubbling in compressed air, and/or using a check valve or other simple structure may be used.

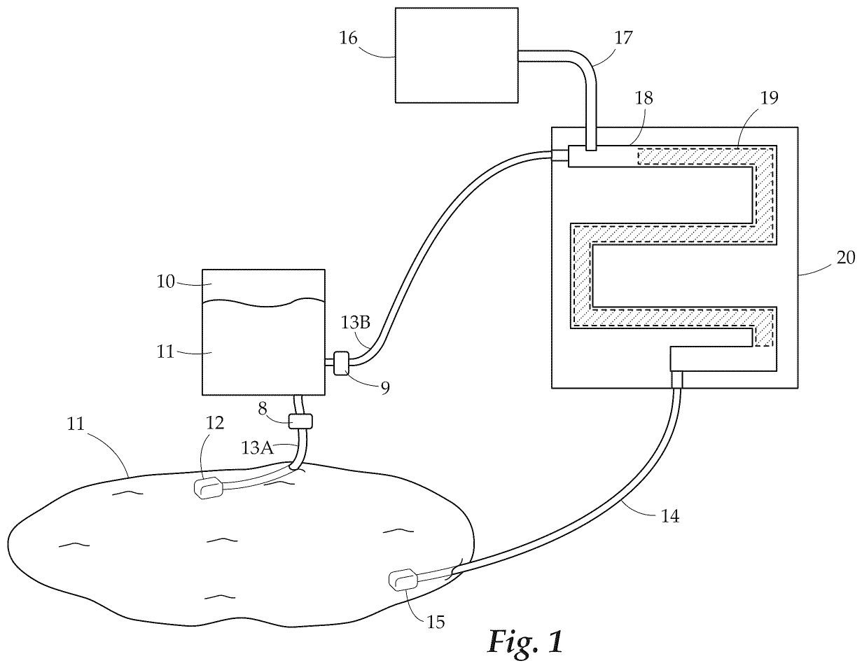

In typical embodiments, for example as shown in FIG. 1, a holding tank is positioned between an intake pump in communication with a body of water intake pump and a second supply pump which delivers fluid to the water treatment cavitation chamber. On the inlet side of supply pump, the inlet pressure is the head pressure in tank which remains mostly stable, give or take a few inches of water. The holding tank between intake pump and supply flow pump equalizes and stabilizes the pressure and allows the two pumps to work evenly. This provides a more efficient and easy-to-implement solution compared to a single large pump providing both intake and supply, or a two pump system where the pumps are carefully synchronized-which requires precise pumps and/or a complex control system.

In many embodiments, the cavitation structure contemplated herein is positioned within a piping through which the contaminated inlet water may flow. The cavitation structure comprises a plurality of sharp edges in the fluid facing direction. The more length (measured as a linear measurement such as inches or feet) of sharp edges, the more aggressive the cavitation will be. The cavitation structure is operable to cause cavitation of fluid flowing past it upon reaching a predetermined threshold flow rate. In other words, the flow velocity must meet a predetermined lower limit before cavitation will begin, as is the case for any cavitation system. The need for adequate flow velocity is balanced with the desire to manage pressure drop across the system. It has been surprisingly found that, the more length of cavitation structure edge, the more compressed air is needed. Therefore, compressed air flow rate will be adjusted based on the cavitation structure, namely the perimeter edge length of the static mixers (i.e. cavitation structures).

In one embodiment, a cavitation structure, system, or manifold, such as that disclosed in U.S. Pat. Nos. 8,858,064 or 8,936,392 may be used. Such devices, or equivalents, produce extremely high amounts of cavitation which have been unexpectedly found to destroy both red tide organisms and breaks down biological compounds, but also greatly aids in the mixing and dissolving of the oxygen and other gas into the water. This dissolved gas, especially dissolved oxygen, aids in oxidation of additional organisms and organic substances, even further treating the water. Of course, in other embodiments, different cavitation geometries and structures may also be employed without straying from the scope of this disclosure. In typical embodiments, the cavitation structure is a “static mixer” i.e. a plurality of sharp or angled surfaces facing the fluid flow direction to disrupt fluid flow and cause cavitation. The static mixers may be integrally formed into the pipe, or removably placed or fitted within a traditional pipe. In other embodiments, the cavitation structure may be a dynamic mixer having one or more blades or panels moving within the cavitation system, for example a propeller designed and operated to cause cavitation of the fluid. The static mixer and dynamic mixer are both forms of hydrodynamic cavitation systems and are different from other cavitation devices such as a venturi cavitation device.

In a particular embodiment, the water treatment system contemplated herein may utilize 100 linear feet of 4″ piping having the cavitation structure along the 100 linear feet. Additional small sections at beginning and end, and optionally at points in the middle, may provide limited non-cavitation flow in varying embodiments.

In some embodiments, upstream of the cavitation structure, compressed air is injected into the fluid at a flow rate of approximately 10 to 100 cubic feet per minute (cfm) and a pressure of approximately 15-150 pounds per square inch (psi). The contaminated water flow rate may generally be in a range of 100 gallons per minute (gpm) to 4000 gpm. Such a system may be run continuously for an extended period of time with minimal energy input requirements (the water pump and air compressor only), and achieve a full or nearly full kill of red tide and full or nearly full breakdown of brevetoxins in moderately red tide-contaminated water. In certain embodiments dealing with extreme contamination, the compressed air pressure and flow rate may be increased, and/or water flow may be adjusted, without requiring any other modifications of the system, providing a highly effective and easily adjustable water treatment system.

It has been unexpectedly discovered through testing that the outlet fluid of the present disclosure is saturated and even super-saturated with dissolved oxygen. High levels of dissolved oxygen, as discussed above, increases the amount of oxygen available to oxidize and otherwise react and break down red tide, harmful algae blooms (“HAB”), toxins such as brevetoxins, and the like. The high levels of dissolved oxygen causes the outlet water to be able to continuously “treat” i.e. react with components in the water after leaving the treatment system. Further still, the high concentration of dissolved oxygen in the outlet water means that an entire body of water need not be treated for effective reduction and destruction of contaminants (red tide, brevotoxins, HAB, and the like). Instead, only a percentage need be treated, and the outlet fluid which carries a large amount of dissolved oxygen mixes with the remaining water, raising the net dissolved oxygen in the total fluid, which again is able to react with contaminants, breaking them down without needing to pass through the cavitation system. In addition, as noted above, micro and nano sized bubbles remain floating or otherwise entrained in the outlet water for, in some cases, days. These bubbles are able to either dissolve into the water, increasing the dissolved oxygen of the water, or can react with biologic matter at the gas-water interface. This further treats the water and allows the outlet water to effectively treat water that it is mixed with outside of the water treatment system. In some cases, such nanobubbles may even sink, providing increased oxygen availability to lower depth water. Contents of the nanobubbles are typically air or compressed air, but also may be at a higher oxygen concentration than air due to reactions occurring during the cavitation process. Exemplary sized nanobubbles may have diameters of approximately 200 nm or less. Exemplary sized microbubbles may have diameters of approximately 1-10 micrometers.

Also surprisingly, it has been observed that the outlet water from testing embodiments causes flocculation in the outlet water itself as well as surrounding water when returned to the body of water, which reduces turbidity. Reduced turbidity in turn allows more sunlight into the water which in turn substantially reduces contaminants and undesirable water components, leading to an overall healthier water body. While outlet water will come out cloudy, flocculation occurs fairly promptly, sinking the mixed components to the bottom. It is believed that this effect is a result of both the cavitation reducing the surface tension within the treated outlet water, as well as the increased dissolved oxygen reducing the surface tension in the treated outlet water. Notably, this effect carries forth when the treated water is released back into the body of water, in another way that the treated water is able to further treat water that it mixes with. In this case, reducing turbidity and allowing sunlight to decontaminate the water.

In one embodiment, the water treatment system may be a fixed installation. In a further embodiment, the water treatment system may have a housing or building or other fixed structure surrounding the piping and other system components. Fixed installations may be located at locations with a high recurrence or likelihood of red tide contamination, such as runoff streams and drainage areas, culverts, and the like. Fixed locations may also be positioned at beaches, harbors, and other high traffic marine areas which are both susceptible to red tide infestations due to less turbulent water, and more negatively impacted by red tide due to a higher concentration of people and activity. Fixed locations may also accommodate larger installations of the system.

In other embodiments, the water treatment system may be portable and mounted on a skid, trailer, and the like. This may allow the water treatment system to be moved to a location where needed. Given the system's low power requirements (by only utilizing hydrodynamic cavitation and compressed air or concentrated oxygen) it is easily operated in remote locations by a battery power system or generator.

Typical embodiments designed for treatment of red tide contaminated water, and designed to kill red tide organisms as well as break down brevetoxins, in most embodiments, utilize only the hydrodynamic cavitation combined with compressed air (or concentrated oxygen) to completely and adequately treat the water and remove both organism and toxin. Thus, additional other and alternative treatment methods in combination of these two systems are, in most cases, not contemplated in the present system.

In some embodiments, the water system may have a filter or filtration assembly on the outlet side to capture solids for the purpose of, e.g. nutrient reduction in the return water. The solids, if returned to the water, will eventually decay into available nutrients even though they are no longer toxic.

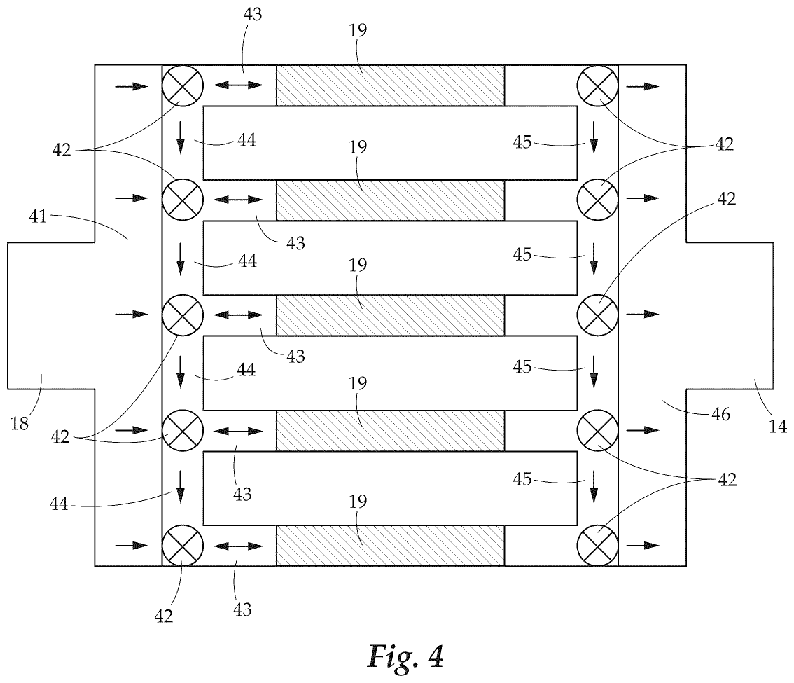

In one embodiment, such as that of FIG. 4, the cavitation chamber may comprise a plurality of flow through chambers. A plurality of valves are able to control the flow direction to cause the water to be treated to flow through just a single section, or through a plurality of sections, or even through each section, back and forth, depending on the amount of residence time in the cavitation section that is needed to reduce the red tide, brevetoxins, HAB's or the like. Put simply, when treating less contaminated water, a single pass (lower residence time) through one of the cavitation sections will be sufficient to fully treat the water; moderately contaminated may require two or more passes, while heavily contaminated water may require even more passes (longer residence time). Depending on embodiment, the valve configuration may be adjusted by a computerized control system using, e.g. actuators to open and close various valves. In other embodiments, each may be manually adjusted. In a particular embodiment, inlet water may be tested to determine a level of contamination. This may be done manually by an operator taking a count of a sample under a microscope, or may be done using a sensor or sensors to identify components or characteristics of the water which may be correlated with level of contamination. An input into a user interface may cause actuation of certain valves in order to properly flow the inlet water through a sufficient length of cavitation chamber in order to provide a desired outlet condition. In some embodiments, the outlet water is intended to be fully treated, i.e. having a red tide, brevetoxin, and/or HAB count of zero. However, in other embodiments, trace amounts or certain low levels of contamination may be tolerable, either because a higher flow rate may be more important than complete treatment, or because the components to be treated need not be reduced to zero. Sensor types contemplated herein, and their measured metrics are discussed below. It has been unexpectedly found that flow through the cavitation system results in a very linear reduction in cell count and toxin count. As such, fluid flow configuration as far as flow length in the cavitation chamber may be predictably configured so as to provide the desired outlet flow conditions (i.e. zero undesirable components, or trace/low amounts, depending on needs). In a further embodiment, if additional treatment is required, the entire flow may be recycled repeatedly through the cavitation chamber until the flow reaches the desired outlet conditions. Recycle flow control may be controlled by, e.g. a computerized control system with valve actuators to control flow direction and residence time. As can be seen in FIG. 4, the multiple valves and cavitation chambers allow for many different flow configurations.

In certain embodiment the water treatment system may have a control system to control and optimize operation. Such an embodiment may utilize one or more sensors able to measure an operational condition. The sensor(s) may be in communication with a computerized controller which receives the sensor input and is able to adjust operational parameters on, for example, a pump, compressor, flow controllers, valves, and the like. In particular embodiments, the computer controller may have a user input interface, an output screen, and/or a network communication port allowing communication with a separate computer.

In various embodiments, exemplary sensors may include, but are not limited to: Temperature sensors at inlet, outlet and/or various points along the fluid flow path, as well as temperature sensors on pumps and/or compressor(s); Pressure sensors at inlet, outlet and/or various points along the fluid flow path, as well as pressure sensors on pumps and/or compressor(s), and compressed air introduction; pH sensors at inlet and/or outlet; oxygen reduction potential (ORP) at outlet and optionally inlet, as well as optionally various points along the fluid flow path; Oxygen saturation, typically at the outlet flow but optionally at inlet and along the fluid flow path; volume flow rate sensors along the fluid flow path, inlet, and outlet, and/or on the pump(s); voltage sensors, amperage sensors, and the like. The computerized control system, or an operator, may make operational adjustments based on sensor inputs to maintain the system in a desired operational condition. For example, if ORP at the outlet is not at the desired level, cavitation time may be increased or decreased by adjusting flow rate, valve configurations, increasing compressed air flow rate or pressure, and the like. Similar adjustments may be made based on sensed oxygen saturation, pH, temperature, and other sensors noted above. As will be understood to those skilled in the art, adjustments requiring increased treatment (i.e. an outlet flow that remains contaminated above target amount) will relate to increasing residence length/time in the cavitation chamber, either through recycle or adjustment of valving as discussed herein, as well as increasing the amount of oxygen introduced, either through increasing compressed air pressure or increasing volume flow rate at a set pressure, or both. Similarly, if sensors indicate that outlet water is being excessively treated, treatment may be scaled back to allow for faster overall flow and lower operating costs, by reducing cavitation length/time and/or reducing amount of oxygen introduced by lowering pressure, flow rate, or both.

One important measurement relating to effectiveness of the treatment of the system is Oxygen Reduction Potential (ORP) of the treated water. ORP measures the ability of water to cleanse itself or break down waste products, such as contaminants and dead plants and animals. When the ORP value is high, there is typically a high amount of oxygen present in the water. ORP is a measurement of electron activity in a medium that relates to the relative amount of oxidant or reductant, for our purpose that medium is water. This characteristic is measured in millivolts by an ORP probe, with higher readings correlating to a more sanitary water system. In general, the higher the ORP value, the healthier the body of water is and the cleaner the treated water is (with respect to red tide or HAB contamination levels). It has been discovered through testing of the present system that, in many embodiments, an ORP of greater than 450 mV indicates that the water is clean and treatment has been effective. However, an excessively high ORP can have negative side effects such as harming or killing fish and other aquatic life. Therefore, in many embodiments an output flow ORP is targeted between 450 to 600 mV. Adjustment can be made, as discussed herein, to the flow rates, flow configuration (regarding length of cavitation exposure, fluid flow rates, compressed air flow rate and pressure, and the like) to control the output water ORP to the desired range.

Turning now to FIG. 1, an embodiment of the present disclosure is shown. The system has a water inlet piping 13A, 13B which is positioned in a body of red tide contaminated water 11. The inlet piping has a filter 12 such as a screen or perforated manifold to prevent intake of large solids such as rocks, fish or other marine life, plants, and the like. Contaminated water 11 is pumped into a holding tank 10 by pump 8 via path 13A. A second pump 9 conveys the contaminated water 11 from the holding tank 10 to the inlet of piping 18 for treatment. As noted above, the water inlet piping 13A, 13B may be rigid and configured to be at a specific level of the water (such as at the surface, the bottom, or between), or may have a flexible portion with buoyancy control for proper depth placement (such as a float, weight, or the like). A housing 20 contains certain components of the system. Inside the housing is cavitation chamber 18 shown here as a quantity of piping through which the water having the red tide contamination may flow. Within the piping 18 is a cavitation structure 19. In this embodiment, the cavitation structure is a static mixer 19 having a plurality of angled or sharp baffles and/or plates with openings therein. The cavitation structure 19 efficiently causes cavitation of the fluid which leads to oxidation, mechanical breakdown, and heat breakdown of both the red tide organism and brevotoxins. In particular, and among other things, the cavitation structure 19 generates hydroxyl radicals. An air compressor 16 connects to the cavitation chamber piping 18 via a flow path 17. In typical embodiments a venturi system is used to inject the compressed air into the piping 18 at a point upstream of the static mixer 19. In further embodiments, additional injection points or “boosters” may be positioned further downstream on the piping to add additional oxygen to the system. At an outlet of the piping 18, the outlet flow is directed via piping 14 back to the body of water via, in this embodiment, manifold 15. Other outlet flow locations may include at an area farther away from the intake area in the same body of water, or to a separate outlet flow such as a drainage system or alternative location. During proper operation of the system, the outlet flow of water does not contain any or only trace or acceptable amounts of HAB, and/or red tide such as Karena brevis and brevetoxins. For example, the state of Florida considers above 5000 cells per liter of red tide organisms unsafe. For purposes of this disclosure the term red tide contamination will refer to water having a red tide cell concentration of greater than approximately 5000 cells/Liter. Therefore, in one embodiment, a targeted output concentration of red tide cell is below 5000 cells/Liter. For purposes of this disclosure, a “trace” or “negligible” amount of red tide is approximately 1000 cells/Liter or less. By contrast, severe red tide blooms can contain greater than 25 million cells per liter. Meaning that a very substantial kill rate is needed to reduce the water back to acceptable levels. Other target amounts may be selected depending on organism type being targeted, location (i.e. state or local regulations), and the like.

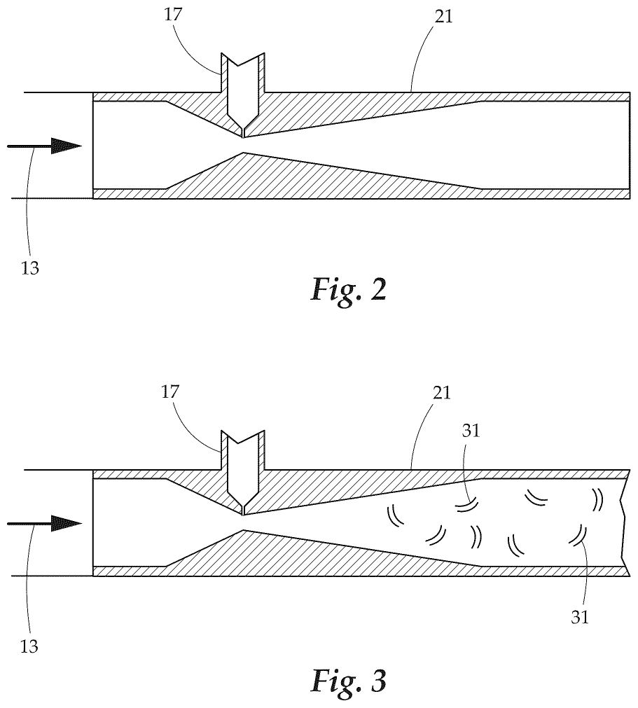

FIG. 2 shows an embodiment of a venturi injector used in the present system to introduce compressed air or other high-oxygen gas. High oxygen gas refers to a gas having a greater amount of oxygen by volume than ambient air, such as compressed air or concentrated oxygen, for example). The contaminated fluid flow 13 passes through the venturi injector 21 which has a reduced diameter flow section, increasing its velocity, and a wider diameter section at its right side, decreasing flow velocity. The compressed air flow path 17 is positioned at the reduced diameter flow section, causing the compressed air flow to get “sucked” into the fluid flow. The increased oxygen from the compressed air increases the oxygen availability during cavitation, leading to substantially increased reaction of oxygen with the organic material of both the brevetoxins and red tide organism and in turn causing very highly efficient water treatment.

FIG. 3 provides a view of an embodiment of the cavitation structure 31 shown here as a static mixer having a plurality of internal baffles 31 which have sharpened leading faces. The sharp leading faces cause efficient cavitation, and the greater the linear distance of sharp face, the greater the cavitation. As noted above, it has been surprisingly found that the amount of compressed air 17 relative to water flow rate 13 increases relative to the amount of linear sharp face 31. This is due likely to a greater amount of cavitation consuming the introduced oxygen.

One embodiment of a system having variable cavitation flow chamber configurations is shown in FIG. 4. This view has the intake fluid flow path 18 entering a manifold 41. The manifold distributes flow through one or more piping 43 having a cavitation chamber 19 which may be run in parallel or series, or a combination thereof, depending on valve configuration. Valves 42 may be operated to orient flow in various directions, such as into or out of a cavitation chamber 19, or through a redirect flow path 44, 45 which directs the flow from a first cavitation chamber 19 to a second cavitation chamber 19 in series. Or the valve 42 may block flow entirely. Once adequately treated by the cavitation system, outlet flow passes to manifold 46, and then outlet 14. Put simply, this configuration allows an operator and/or a programmed computer to modify the flow configuration to achieve the desired amount of treatment cavitation length—with more cavitation flow resulting in a higher kill rate for more contaminated water, but a lower flow rate through the system, or a faster flow rate through, with multiple chambers allowing more flow rather than excessive treatment—for treating less contaminated water and/or for treating more water faster.

FIG. 5 provides a flow chart of treatment of water contaminated with red tide and brevetoxin showing an initial cell and toxin concentration, as well as outlet concentrations after two different treatments. The bars relate to brevetoxin levels as shown on the left axis, while the dots at the top of each represents cell concentration as shown on the right axis. As can be seen, the control (inlet) concentration of both is quite high, and is drastically reduced with even the short residence time of the “Cavitation S.P. w/ Compressed Air” treatment, which represents a single pass through the cavitation chamber. Adjusting valve and circulation flow (as discussed above) to have a 15 minute residence time, using only cavitation and compressed air, brings the concentrations of both brevetoxin and red tide cells down to near zero and at trace levels. These results were unexpected given the known difficulty in treatment of water with red tide contamination. Typical prior art approaches, as noted above, utilize aggressive, expensive, and difficult-to-scale systems such as ozone treatment.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth.

What is claimed is

1. A system for treatment of water comprising:
a cavitation chamber having a fluid inlet to receive a water flow comprising Karena brevis and brevetoxins, a fluid outlet, and a cavitation structure operable to cause a cavitation of fluid passing through the cavitation chamber at a predetermined minimum flow rate;
a pump operable to convey fluid through the cavitation chamber;
an air compressor in communication with the cavitation chamber;
an injector in communication with the air compressor and positioned so as to introduce compressed air from the air compressor into a flow path upstream of the cavitation structure.

2. The system for treatment of water of claim 1 wherein the cavitation structure is a static mixer comprising a length of sharp edge.

3. The system for treatment of water of claim 1 wherein the water inlet is in fluid communication with a body of water comprising Karena brevis and brevetoxins.

4. The system for treatment of water of claim 3 further comprising a quantity of water comprising Karena brevis and brevetoxins within a portion of the cavitation chamber.

5. The system for treatment of water of claim 4 further comprising a quantity of water that does not contain any or only trace amounts of Karena brevis and brevetoxins at the fluid outlet.

6. The system for treatment of water of claim 1 wherein the air compressor is configured to provide compressed air at a pressure of at least 2 atmosphere.

7. The system for treatment of water of claim 1 wherein the compressed air and cavitation chamber are the only components used for reduction in contamination.

8. The system for treatment of water of claim 1 wherein injector is a venturi injector.

9. The system for treatment of water of claim 1 further comprising at least one sensor, the at least one sensor in communication with a computer controller operable to control at least one of the pump and the air compressor.

10. A system for treatment of water comprising red tide contamination or a harmful algal bloom comprising:
a cavitation chamber having a fluid inlet to receive a water flow comprising the red tide contamination or harmful algal bloom, a fluid outlet, and a cavitation structure operable to cause a cavitation of fluid passing through at a predetermined minimum flow rate;
a pump operable to convey fluid through the cavitation chamber;
an gas inlet in communication with the cavitation chamber;
a venturi injector in communication with the gas inlet and positioned so as to introduce compressed air or gas into a flow path defined by the cavitation chamber.

11. The system for treatment of water of claim 10 further comprising an air compressor in communication with the gas inlet.

12. The system for treatment of water of claim 10 further comprising an oxygen concentrator in communication with the gas inlet.

13. The system for treatment of water of claim 10 wherein the venturi injector is positioned upstream of the cavitation structure of the cavitation chamber.

14. The system for treatment of water of claim 10 wherein the water inlet is in fluid communication with a body of water comprising a harmful algal bloom and/or a contamination of Karena brevis and brevetoxins.

15. The system for treatment of water of claim 14 further comprising a quantity of water comprising a harmful algal bloom and/or Karena brevis and brevetoxins within a portion of the cavitation chamber.

16. The system for treatment of water of claim 15 further comprising a quantity of water that does not contain any or only trace amounts of harmful algal bloom and/or Karena brevis and brevetoxins at the fluid outlet.

17. A method of treating water comprising the steps of:
positioning a fluid intake into a body of water contaminated with Karena brevis and brevetoxins, the fluid intake in communication with a water treatment device comprising a hydrodynamic cavitation chamber and an air compressor for introducing compressed air to fluid flow within the cavitation chamber;
activating a pump to convey the water through the cavitation chamber;
activating the air compressor to introduce the compressed air to the water flow;
wherein the step of activating the pump comprises conveying fluid at a flow rate sufficient to cause cavitation of the water within the cavitation chamber; and
conveying the fluid to the body of water after passing through the cavitation chamber, the fluid at an outlet of the cavitation chamber having no, or only a trace amount of Karena brevis or brevetoxin.

18. The method of claim 17 wherein the step of activating the air compressor comprises providing compressed air at a pressure of at least 2 atmosphere.

19. The method of claim 17 wherein the step of activating the air compressor comprises providing compressed air at a pressure of at least 3 atmosphere.

20. The method of claim 17 wherein the step of activating the air compressor to introduce compressed air to the water flow comprises the step of conveying the compressed air through a venturi injector and injecting the compressed air upstream of a cavitation structure in the cavitation chamber.
